(19) United States
(12) Patent Application Publication
(10) Pub. No.: US 2006/0255590 A1
(43) Pub. Date: Nov. 16, 2006

(54) Duct assembly with dual spin weld coupler

(76) Inventor: Daniel Russell Ludeman, Clinton, WI (US)

Correspondence Address: HARNESS, DICKEY & PIERCE, P.L.C., P.O. BOX 828, BLOOMFIELD HILLS, MI, 48303, US

(21) Appl. No.: 11/125,611

(22) Filed: May 10, 2005

(51) Int. Cl. F16L 13/02

(52) U.S. Cl. 285/288.1

(57) ABSTRACT

A method for forming an article having a first duct portion, a second duct portion and a coupling portion intermediate the first and second duct portions. The method includes substantially simultaneously spin-welding the first duct portion, the coupling portion and the second duct portion together to form a duct. A fluid-conveying article is also provided.

The present invention generally relates to duct systems for conveying a fluid and more particularly to a complexly shaped duct and a method for its formation.

Many duct systems, particularly those for automotive vehicles, employ one or more plastic duct members that are formed via blow molding or suction blow molding. Blow molding and suction blow molding techniques, however, cannot be employed to fabricate a duct having relatively complex routing or shape requirements, such as the one illustrated in FIG. 1. In situations where ducts systems of this complexity would be desirable, the duct system would be fabricated in two or more discrete sections and subsequently assembled to one another. The joint connecting the discrete sections would typically employ a hose-like coupling and two clamps for fixedly and sealingly connecting the hose-like coupling to a corresponding end of one of the discrete sections.

Configuration of a duct system in this manner, however, is not desirable since each joint increases the number of overall components in the duct system, increases the amount of labor that is required to assemble the duct system and increases the potential for a leak in the duct system. Accordingly, there remains a need in the art for an improved duct system and a method for its construction.

### SUMMARY

In one form, the present teachings provide a method for forming an article having a first duct portion, a second duct portion and a coupling portion intermediate the first and second duct portions. The method includes substantially simultaneously spin-welding the first duct portion, the coupling portion and the second duct portion together to form a duct.

In another form, the present teachings provide a method for forming a duct. The method includes: providing a first duct section; providing a second duct section; interposing a coupling section between the first duct section and the second duct section; and spin-welding the first and second duct sections to the coupling section by spinning either the coupling section or both the first and second duct sections.

In yet another form, the present teachings provide a article having a first duct portion, a second duct portion and a coupling portion that is disposed between the first and second duct portions and which is fixedly and sealingly engaged to the first and second duct portions at opposite ends via spin-welding.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a

### DETAILED DESCRIPTION OF THE VARIOUS EMBODIMENTS

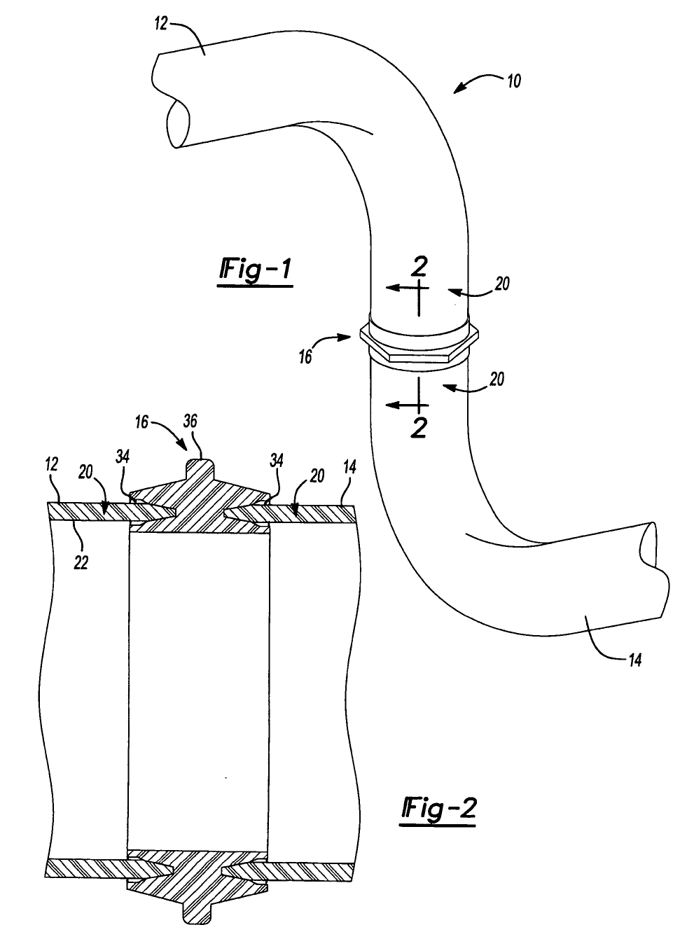

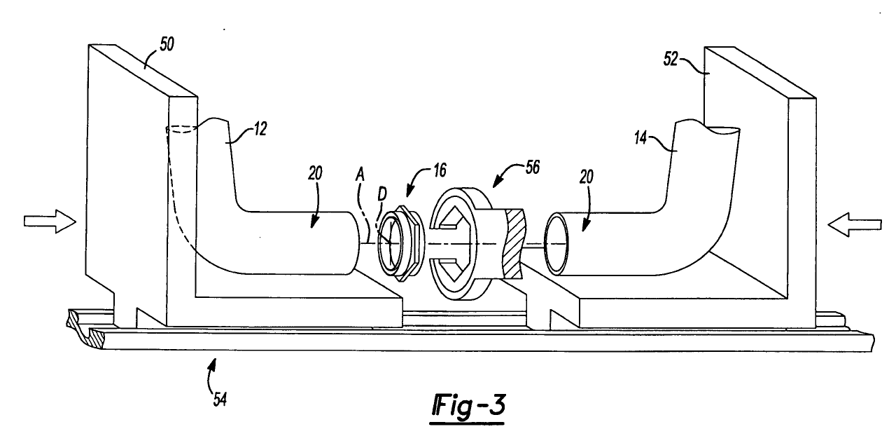

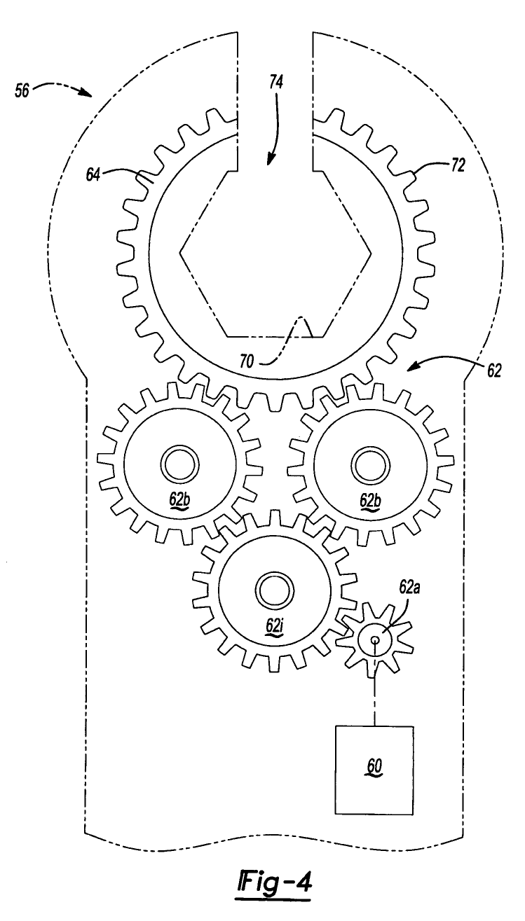

With reference to FIG. 1 of the drawings, a duct constructed in accordance with the teachings of the present invention is generally indicated by reference numeral 10. The duct 10 can have a first duct portion 12, a second duct portion 14 and a coupling portion 16 intermediate the first and second duct portions 12 and 14. With additional reference to FIG. 2, each of the first and second duct portions 12 and 14 can be formed via molding, such as blow molding or suction blow molding and can include a coupling end 20 that can have a wall member 22 that defines a longitudinally extending cylindrical protrusion 24. It should be noted that one or both of the first and second duct portions 12 and 14 can have relatively complex geometry and/or shaping as is illustrated in the example provided. In this regard, portions of the first or second duct portions 12 and 14 may extend radially outwardly of a spin-weld axis A by a dimension of twelve (12) inches or more.

The coupling portion 16 can include a pair of mating coupling ends 30. In the particular example provided, the coupling portion 16 is formed via injection molding and each of the mating coupling ends 30 includes a wall member 32 having an annular groove 34 formed therein. The coupling portion 16 can have a non-circular cross-section that can be employed to rotate the coupling portion 16 during a spin-welding operation that will be discussed in greater detail, below. In the particular example provided, the coupling portion 16 includes a hex-shaped drive portion 36.

With reference to FIG. 3, the first and second duct portions 12 and 14 can be fixtured into first and second jigs 50 and 52, respectively, of a spin-welding machine 50. The first and second jigs 50 and 52 can be configured to orient the first and second duct portions 12 and 14, respectively, along a spin-weld axis A and relative to a predetermined datum D.

The collar portion 16 can be positioned between the first and second jigs 50 and 52 so as to be spaced apart from the first and second duct portions 12 and 14. A toolhead 56 can engage the collar portion 16 and cause the collar portion 16 to rotate. The toolhead 56 can be configured to frictionally engage the collar portion 16 to transmit rotary power or can be configured to engage the collar portion 16 in a more positive manner. With reference to FIG. 4, the toolhead 56 in the particular example provided can include a drive motor 60, a geartrain 62 and an output socket 64. The geartrain 62 can include an input gear 62a, which is configured to receive rotary power from the motor 60, a pair of output gears 62b, and one or more intermediate gears 62i that transmit rotary power between the input gear 62a and the output gears 62b. Note that as each of the output gears 62b is meshingly engaged to a common one of the intermediate gears 62i, the output gears 62b will rotate at the same speed and in the same direction. The output socket 64 includes a socket aperture 70 and a plurality of gear teeth 72 that meshingly engage the output gears 62b. The socket aperture 70 is configured to matingly engage the hex-shaped drive portion 36 of the coupling portion 16 but includes a lateral slot 74 that permits the tool head 56 to be withdrawn from the coupling end 20 of the second duct portion 14 as will be discussed in detail below.

Activation of the motor 60 causes the output gears 62b to rotate the output socket 64 to thereby rotate the coupling portion 16 about the spin-weld axis A. Since the output gears 62b are spaced about the perimeter of the output socket 64 by a circumferential dimension that exceeds the width of the lateral slot 74, the geartrain 62 will transmit rotary power to the output socket 64 regardless of the position of the lateral slot 74. When the coupling portion 16 is rotated at a speed in excess of a predetermined speed, the jigs 50 and 52 can be indexed toward one another along the spin-weld axis A to predetermined positions C and D, respectively, wherein the longitudinally extending cylindrical protrusion 24 of each coupling end 20 is frictionally engaged with the annular groove 34 of a corresponding one of the mating coupling ends 30 so that further rotation of the coupling portion 16 will generate sufficient heat to cause the interface between the coupling ends 20 and the mating coupling ends 30 to melt and bond together. The motor 60 may thereafter be deactivated and then activated (if necessary) to align the lateral slot 74 to a desired location relative to the remainder of the toolhead 56. Thereafter, the toolhead 56 may be translated in a direction parallel to the spin-weld axis A to a position that is in-line with a desired portion of the duct 10, such as the coupling end 20 of the second coupling portion 14, where the toolhead 56 may be moved in a direction that is generally transverse to spin-weld axis A to thereby disengage the toolhead 56 from the duct 10.

While the invention has been described in the specification and illustrated in the drawings with reference to various embodiments, it will be understood by those skilled in the art that various changes may be made and equivalents may be substituted for elements thereof without departing from the scope of the invention as defined in the claims. Furthermore, the mixing and matching of features, elements and/or functions between various embodiments is expressly contemplated herein so that one of ordinary skill in the art would appreciate from this disclosure that features, elements and/or functions of one embodiment may be incorporated into another embodiment as appropriate, unless described otherwise, above. Moreover, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the foregoing description and the appended claims.

What is claimed is:

1. A method for forming an article having a first duct portion, a second duct portion and a coupling portion intermediate the first and second duct portions, the method comprising substantially simultaneously spin-welding the first duct portion, the coupling portion and the second duct portion together to form a duct.

2. The method of claim 1, wherein the coupling portion is rotated when the first duct portion, the coupling portion and the second duct portion are spin-welded together.

3. The method of claim 2, wherein the coupling portion has a lateral cross-section having a non-circular shape.

4. The method of claim 1, further comprising forming the first duct portion via blow molding or suction blow molding.

5. The method of claim 4, further comprising forming the second duct portion via blow molding or suction blow molding.

6. The method of claim 1, further comprising forming the coupling portion via injection molding.

7. The method of claim 1, wherein simultaneously spin-welding the first duct portion, the coupling portion and the second duct portion together includes:
locating the first duct portion in a first position that is axially spaced apart from the coupling portion;
locating the second duct portion in a second position that is axially spaced apart from the coupling portion;
rotating the coupling portion;
translating the first duct portion toward the coupling portion; and
translating the second duct portion toward the coupling portion.

8. The method of claim 7, wherein the first and second duct portions are translated toward the coupling portion simultaneously.

9. A method for forming a duct comprising:
providing a first duct section;
providing a second duct section;
interposing a coupling section between the first duct section and the second duct section; and
spin-welding the first and second duct sections to the coupling section by spinning either the coupling section or both the first and second duct sections.

10. The method of claim 9, wherein the first and second duct sections and the coupling section are spin-welded together simultaneously.

11. The method of claim 9, wherein the coupling section is rotated and the first and second duct sections are translated toward one another when the first and second duct sections and the coupling section are spin-welded together.

12. The method of claim 11, wherein a lateral cross-section through the coupling section has a non-circular shape.

13. The method of claim 11, wherein the coupling section is formed via molding.

14. The method of claim 13, wherein the coupling section is formed via injection molding.

15. The method of claim 9, wherein providing the first duct section includes molding at least a portion of the first duct section.

16. The method of claim 15, wherein the at least the portion of the first duct section is formed via blow molding or suction blow molding.

17. The method of claim 15, wherein providing the second duct section includes molding at least a portion of the second duct section.

18. The method of claim 17, wherein the at least the portion of the second duct section is formed via blow molding or suction blow molding.

19. An article comprising:
a first duct portion;
a second duct portion; and
a coupling portion disposed between the first and second duct portions, the coupling portion being fixedly and sealingly engaged to the first and second duct portions at opposite ends via spin-welding.
